(19) United States
(12) Patent Application Publication
(10) Pub. No.: US 2017/0241157 A1
(43) Pub. Date: Aug. 24, 2017

(54) Improvements to Retractable Awnings

(71) Applicant: Danny Smith, Forest Glen, Queensland (AU)

(72) Inventor: Harold Phillips, Forest Glen, Queensland (AU)

(73) Assignee: Danny Smith, Forest Glen, Queensland (AU)

(21) Appl. No.: 15/507,740

(22) PCT Filed: Sep. 10, 2015
(86) PCT No.: PCT/AU2015/000559

§ 371 Date: Feb. 28, 2017

(30) Foreign Application Priority Data
Sep. 10, 2014 (AU) 2014222379

(51) Int. Cl. E04H 15/08; E04F 10/06; B60P 3/34

(52) U.S. Cl. CPC E04H 15/08; B60P 3/343; E04F 10/0685; E04F 10/0614; E04F 10/064; E04F 10/0648; E04F 10/0692

(57) ABSTRACT

An awning assembly including: a longitudinal support assembly adapted to be fixed to a supporting wall and from which a flexible covering may be withdrawn to provide an awning roof extending from the supporting wall and retracted for stowage; a longitudinal rail assembly attached to the outer longitudinal edge of the flexible covering; at least one strut assembly connected at one end to the longitudinal rail assembly and at its opposite end to a slide assembly adapted to be fixed to the supporting wall such that movement of the longitudinal rail assembly away from the supporting wall causes travel of the opposite end of the strut assembly along the slide assembly from a stowed position to a deployed position, and control means for locating the strut assembly during movement between its stowed and deployed positions.

### TECHNICAL FIELD

This invention relates to improvements to retractable awnings which are particularly suited for attachment to caravans and the like.

### BACKGROUND

Many caravans are fitted with a roll out awning on the entry door side of the caravan. Typically the awning extends from a permanent mounting along the wall of the caravan above the entry door and the remote extremities of the awning are supported by poles to enable the support of associated sidewalls so as to form an enclosed annex.

The ease of erection of the awning is relatively important however other considerations such as the ease of adding the sidewalls to enclose the space beneath the awning is also a factor in the desirability of an awning. However there are many instances when a traveller may pull to the side of the road for a short break and in such instances the ease of erecting the awning will determine whether or not it is deployed.

One such awning type utilises a roller assembly supported by a support means at each end which can pivot away from the caravan to unroll and deploy the flexible awning from the roller assembly, the inner end being of the flexible covering being fixed to the caravan. In order to provide the maximum awnings span the arms are substantially equal to the height of the caravan and their pivot attachment thereto is through a slide assembly for vertical movement along the wall of the caravan. While such awning types are effective in use and are relatively easy to deploy, the support of the roller assembly remote from the caravan can impose high point loadings on the frame which attaches the awning to the caravan wall and over time this can cause problems with leakage and damage to the caravan cladding.

The selection of an awning for a caravan will be based on many criteria desired by the owner. However as the side wall configuration of a caravan which contains the entry door varies widely from caravan to caravan it is desirable that the mounting to the caravan be of such form that it can be readily adjusted so that it does not obstruct or obscure any opening through the side wall. It may also be desirable to provide an awning assembly having a width which is not limited by the height of the caravan and in some instances it may be desirable to have adjustability of the angle at which the awning extends from the caravan so that the outer edge may be supported at different heights.

Deployed annexes often suffer in windy conditions from flapping of the free edges of the deployed awning cover. This has led to the development and utilisation of anti-flap kits which are often complex and/or difficult to install. This complexity is a result of the need to engage and disengage the free edge with a stiff member which is length adjustable and which can be engaged laterally across the free edge and then operated to secure the free edge to the stiff member. Furthermore as the majority of users of such awnings are older retired travellers, ease and safety of use are major considerations in their selection of a suitable awning/annex.

This invention aims to provide an improved awning assembly which will be effective in use and which will achieve one or more of the desirable features mentioned above and or alleviate at least one of the above-mentioned disadvantages. Other aims of this invention will become apparent from the following description.

### SUMMARY OF INVENTION

With the foregoing in view, this invention in one aspect resides broadly in an awning assembly including:

a longitudinal support assembly adapted to be fixed to a supporting wall and from which a flexible covering may be withdrawn to provide an awning roof extending from the supporting wall and retracted for stowage;

a longitudinal rail assembly attached to the outer longitudinal edge of the flexible covering;

at least one strut assembly connected at one end to the longitudinal rail assembly and at its opposite end to a slide assembly adapted to be fixed to the supporting wall such that movement of the longitudinal rail assembly away from the supporting wall causes travel of the opposite end of the strut assembly along the slide assembly from a stowed position to a deployed position;

extension means for extending the strut assembly from a collapsed condition to an expanded position, and control means for locating the strut assembly during movement between its stowed position and collapsed condition and its deployed position and expanded condition.

In another aspect, the present invention resides broadly in an awning assembly including:

a longitudinal support assembly adapted to be fixed to a supporting wall and from which a flexible covering may be withdrawn to provide an awning roof extending from the supporting wall and retracted for stowage;

a longitudinal rail assembly attached to the outer longitudinal edge of the flexible covering;

at least one strut assembly connected at one end to the longitudinal rail assembly and at its opposite end to a slide assembly adapted to be fixed to the supporting wall such that movement of the longitudinal rail assembly away from the supporting wall causes travel of the opposite end of the strut assembly along the slide assembly from a stowed position to a deployed position, and

control means for locating the strut assembly during movement between its stowed and deployed positions.

The longitudinal support assembly may support the flexible covering in any suitable manner such as on a roller or in a folded arrangement having spaced upper edge portions connected slidably to a tension member which is withdrawn with the longitudinal rail assembly. In one form of the invention the longitudinal support assembly includes an open bottom housing which encompasses the flexible covering and which housing is closed by the longitudinal rail assembly when the flexible covering is retracted into the housing.

The flexible covering is supported on a roller assembly and may be unwound therefrom from the underside of the roller. The connection between the flexible covering and the longitudinal rail assembly may be formed at any suitable location thereon. In a preferred embodiment this connection is located on an outer part of the longitudinal rail assembly such that tension applied through the flexible covering by its retraction onto the roller assembly is sufficient to pull the longitudinal rail assembly toward its closed position at which the longitudinal rail assembly operatively closes the open bottom of the housing so as to shield the flexible covering from sunlight and inhibit debris from accumulating within the housing.

In a preferred form the connection between the flexible covering and the longitudinal rail assembly is effected through a full-length bolt rope connection. Of course it could also be fastened by hook and loop connectors, screwed or riveted, for example. The term “bolt rope connection” when used herein embraces all forms of expanded edging which is adapted to be slidably engaged with a re-entrant track. Furthermore where a weatherproof connection is not required, sail track type slugs may be utilised for slidable capture in the re-entrant track. Furthermore where bolt rope edging is provided at or adjacent transverse edges of the flexible covering, further transversely extending bolt rope edging may be attached to intermediate portions of the flexible covering, and preferably on the underside thereof, to ensure that the wound diameter of the intermediate portion is substantially the same as the wound diameter of the edge portions. The intermediate bolt rope edging may be utilised to support internal wall panels or other utilities as required. It will be appreciated that the term bolt rope as used herein includes alternative forms which provide a thickening of the covering at or near the edge with or without the inclusion of a rope in the hem.

The connection between the longitudinal rail assembly and each strut assembly could be a flexible connection such as a tie or the like but preferably the connection between the longitudinal rail assembly and each strut assembly is a substantially fixed connection such that the longitudinal rail assembly will be rotated as the flexible covering is withdrawn from the longitudinal support assembly to facilitate consistent operative deployment of the awning components and to aid prevention of rain ingress along the connection between the flexible covering and the longitudinal rail assembly. Preferably these connections are adjustable along the length of the longitudinal rail assembly to enable the awning to be configured to suit the layout of the caravan or other vehicle or structure to which it is to be fitted.

For this purpose it is preferred that the slide assembly operates in a vertical direction although the slide assembly could operate in a horizontal direction. A vertical slide assembly has the added advantage that the full length of the strut assembly is elevated in the deployed attitude providing easy access to the covered area from any side, whereas in an arrangement in which the guide rail is horizontal, the inclined deployed strut assembly will partially block access to the covered area from opposite sides of the annex.

The slide assembly could be fixed along the base of the side wall above the wheel arch to enable its length to be longer than the height of the caravan or to provide a fixed full length slide assembly for an awning according to this invention fitted to a pop-top type caravan. For such an application the slide assembly could also be formed as a multi-part slide assembly such as an extendible slide assembly or formed of operatively conjoined slide assembly components. Thus in a pop-top type caravan, the slide assembly could include a lower part fixed to the van body and an upper part fixed pivotally to the pop-top so that it could be pivoted down from the elevated pop-top to align with and form an extension of the lower part to form a full height slide assembly.

The strut assembly could be in the form of a simple strut or it may be in the form of a braced strut such as an A-frame or a Y-frame having a wide stabilising base supported by the caravan or by the longitudinal rail assembly so as to assist in maintaining operative alignment between the longitudinal rail assembly and the caravan. The strut assembly could be an extendible strut assembly, such as pressurised gas strut, if desired.

Any suitable control means may be utilised to control movement of the strut assembly between its stowed and deployed positions. For example a tension member could extend from the longitudinal rail assembly about elevated guide means on the slide assembly to the inner end of each strut assembly such that movement of the longitudinal rail assembly away from the support assembly would cause the tension member to pull the inner end of each strut assembly upward toward the guide means. Alternatively a link could extend from a fixed pivot on the caravan wall to an intermediate pivot on the strut assembly whereby movement of the rail assembly away from support assembly would cause the link to pull the inner end of each strut assembly toward the fixed pivot on the caravan wall.

In a preferred form the control means is a linkage extending between a medial portion of each strut assembly and a fixed pivot point toward which the inner end of the strut assembly moves during retraction of the longitudinal rail assembly. Suitably, where a vertical slide assembly is utilised the fixed pivot point is provided on an upper portion of a vertical slide assembly. Similarly where a horizontal slide assembly is utilised the fixed pivot could be provided adjacent the end of the slide assembly toward which the strut assembly moves during deployment of the flexible covering.

In annexe installations where multiple strut assemblies are utilised to support the support rail, synchronising means may be incorporated to cause each strut assembly to move in unison. The synchronising means may be a simple non-elastic tension stay or a push/pull cable assembly associated with or constituting each control means and passing to synchronised extensionretraction means. In another form a torsion member could extend between spaced strut assemblies and be provided with drive wheels fixed thereto adjacent the inner ends of each strut assembly and engaging the caravan wall so that the inner end of each strut assembly is forced by twisting of the torsion member to move in unison along the caravan wall. Such an arrangement may be especially useful on a large awning.

Each side edge of the flexible covering could be provided with a bolt rope to facilitate sliding connection to an extruded or otherwise formed stiffening bar to stiffen the free side edges of the flexible covering and/or to provide a connector for a flexible wall panel for example. To achieve this the flexible covering could taper toward the rail assembly to enable the turns of the bolt rope when wound onto the support roller to be disposed side by side. Alternatively the support roller could be formed with waisted end portions to accommodate the extra bulk of the bolt ropes. Alternatively the bolt rope could be formed on tapered panels fixed to the side edges and adapted to overly the flexible covering for winding onto the support roller and further adapted to hang from the edges when unfolded to provide a connection to a track member which could be provided as a one-piece member or a multipart member able to be dismantled into shorter lengths for stowage. The edges of the flexible covering could also be provided with zipper components to facilitate connection of additional panels thereto.

In a preferred form the outer corners of the flexible covering are cropped to expose ends of the bolt ropes which may be moved away from adjacent clutter for engagement with an open supporting track or a stiffening bar. Having these exposed ends of the bolt ropes at the outer end of the flexible covering and away from the caravan ensures that they may be easily accessed for sliding engagement of an elongate stiffening bar thereon, which may be full length if desired, telescopic or attached as shorter lengths to form the desired dampening of fluttering of the flexible edges. The bar which is adapted for sliding engagement with the bolt rope edges could also incorporate a retractable side wall panel for selective deployment from the edge of the flexible covering or a further track or tracks for connecting panels, such as end wall panels thereto.

In a preferred form each strut assembly is adapted to nest with the associated slide assembly in the stowed attitude and to be held in their nested position by suitable selectively engageable clamping means. For ease of operation it is preferred that the slide assembly include a slide rail and a wheeled carriage held captive therein for rolling movement along the slide rail and pivotally connected to the strut assemblies. Of course simple slug-type carriages could be used. It is also preferred that the carriages both support a clamp member which may be selectively operated to lock the carriage to the slide rail. Alternatively the slide rail could be formed with indexing means therealong such as spaced apertures which may be aligned with a complementary aperture on the respective carriage to enable a pin to be inserted through the aligned apertures to lock the inner ends of the strut assemblies in a selected position along the slide rails.

Where the strut assembly is an extendible strut extension, this may be achieved by manipulation of the strut assembly or achieved automatically by suitable ropes, gears or linkages actuated by relative movement between the strut assemblies and their guide rails so as to cause automatic extension of the strut assemblies as the support rail is pulled out to its deployed position. It is also preferred that the a longitudinal support assembly, which is preferably in the form of a support housing, be provided with connections which may be releasably engaged with complementary connectors fitted permanently to a strong point on the caravan wall.

In another aspect this invention resides broadly in an awning assembly of the type including:

a longitudinal support assembly from which a flexible covering may be withdrawn to provide an awning roof extending from a supporting wall and retracted for stowage adjacent the supporting wall, wherein:

transverse edge portions of the flexible covering are provided with bolt rope edging which terminates in spaced relationship with the supported longitudinal edge of the deployed flexible covering which is distant from the wall to expose accessible bolt rope ends adjacent said longitudinal edge.

The longitudinal support assembly may be of the type which is attached to the supporting wall or of the type which is carried on arms extending from the supporting wall. The transverse edge portion may be the side edges of the flexible covering or edges of additional panels, such as triangular panels as described herein or intermediate panels.

Preferably the awning assembly includes a stiffening bar adapted to be secured to each respective transverse edge portion by engaging an open end of a captive or re-entrant slot in the stiffening bar with the accessible rope ends and sliding the stiffening bar onto the respective transverse edge portion. The stiffening bar may also be provided with additional captive slots for securing side wall panels or other panels to the transverse edges.

In yet a further aspect, this invention resides in a method of installing a flap dampening member to an unsupported transverse edge of the retractable flexible covering of a caravan awning or the like, including:

providing a bolt rope type edge along said transverse edge such that an end portion of the bolt rope type edge remote from the caravan is accessible for engaging a complementary tracked member therewith for sliding along the bolt rope type edge, and

sliding a complementary tracked member onto the bolt rope type edge from a position spaced from the caravan and in a direction toward the caravan.

Preferably the method includes forming the caravan awning whereby the retractable edge of the flexible covering when deployed may be disposed in a supported lowered position at which the end portion of the bolt rope type edge may be accessed by an installer at a height below the normally deployed height of the retractable edge and more preferably without the installer working above their head. The retractable edge may be supported by a support assembly as variously described herein or it may be supported by other means such as short poles which may be extended, for example, to elevate the retractable edge to its operative deployed position. Preferably the lowered position is one of the deployed positions to which the annex extends when moved to extend the flexible covering.

In order that this invention may be more readily understood and put into practical effect, reference will now be made to the accompanying drawings which illustrate typical embodiments of this invention and wherein:

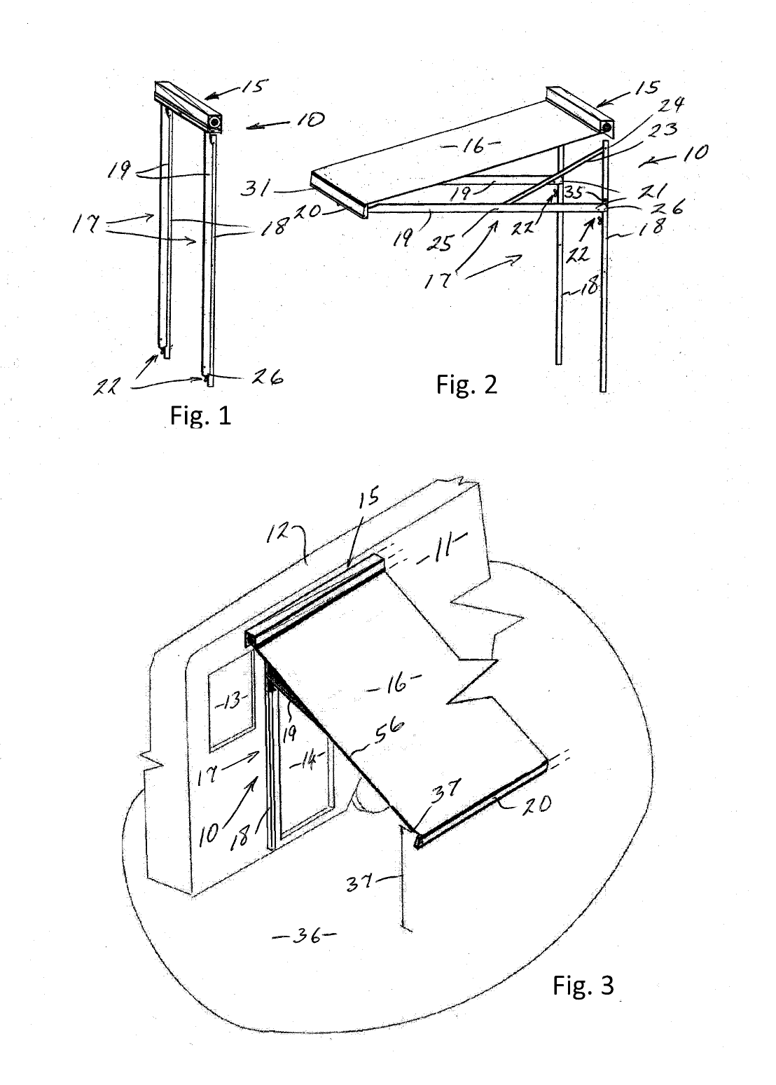

FIG. 1 is a perspective view of a preferred embodiment of an annex assembly according to this invention and illustrated in its stowed attitude;

FIG. 2 is a perspective view corresponding to FIG. 1 illustrating the awning assembly in its deployed attitude;

FIG. 3 is a cutaway perspective view showing a partially deployed awning assembly mounted on a caravan;

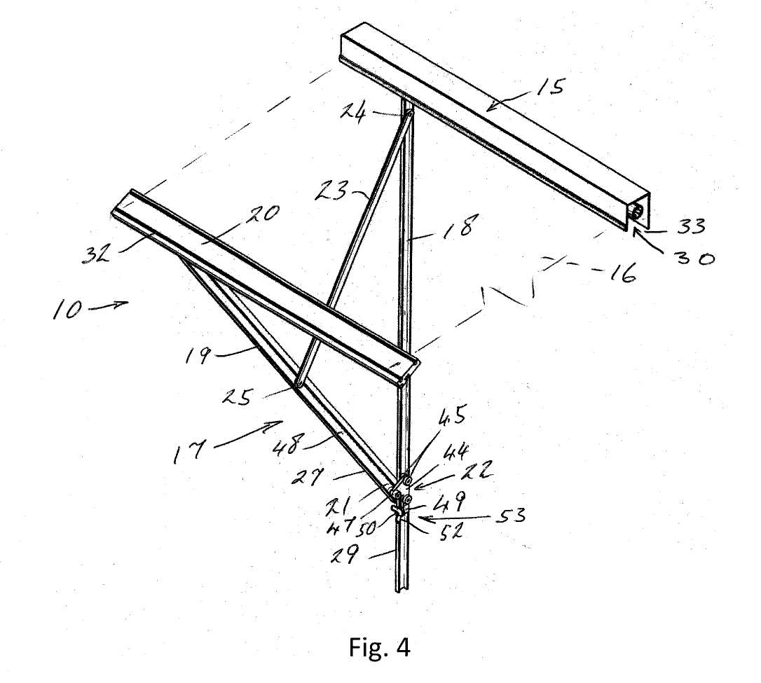

FIG. 4 illustrates one support assembly with the strut and rail sectioned to reveal their connections to one another;

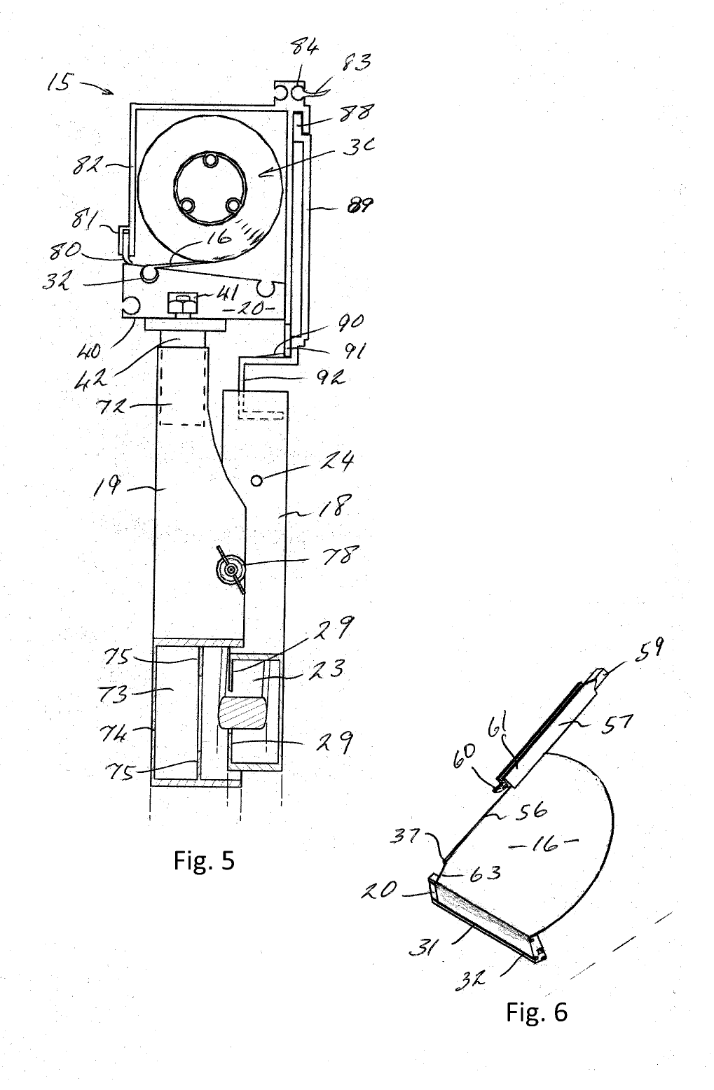

FIG. 5 is an enlarged end view illustrating the connections between the struts, longitudinal rail and housing assembly;

FIG. 6 illustrates the connection between the deployed support rail and flexible covering and the method of stiffening its unsupported edge;

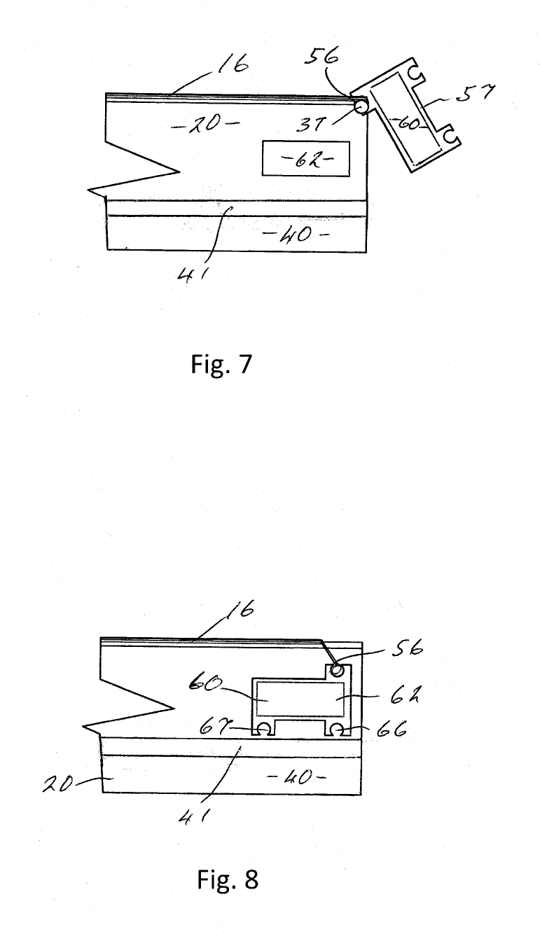

FIGS. 7 and 8 are corresponding inner side views of the deployed support rail and flexible covering and showing the method of securing the flexible edge stiffening bar to the support rail;

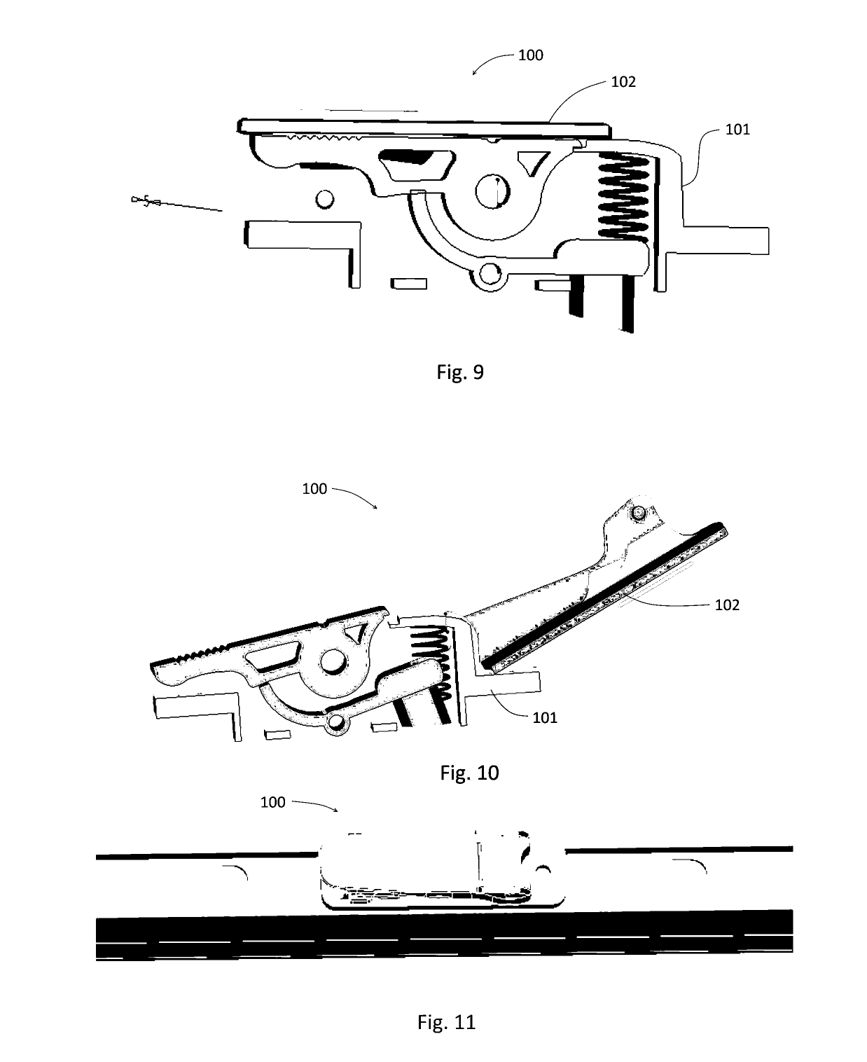

FIGS. 9 and 10 are diagrammatic sectional views of a slide locking mechanism in a locked and unlocked condition respectively;

FIG. 11 is a pictorial view of the locking mechanism of FIGS. 9 and 10;

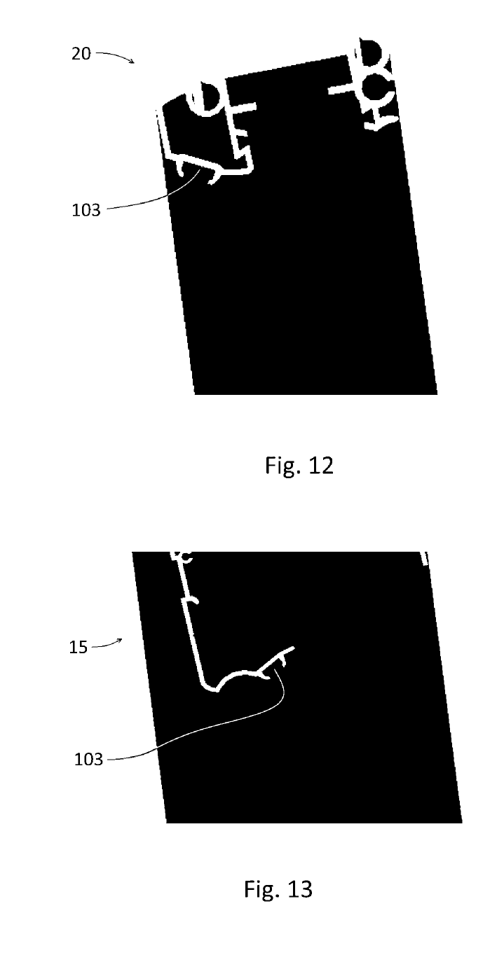

FIG. 12 is a pictorial view showing a section detail of a longitudinal rail for the retractable awning of the present invention;

FIG. 13 is a pictorial view showing a section detail of a side rail for the retractable awning of the present invention;

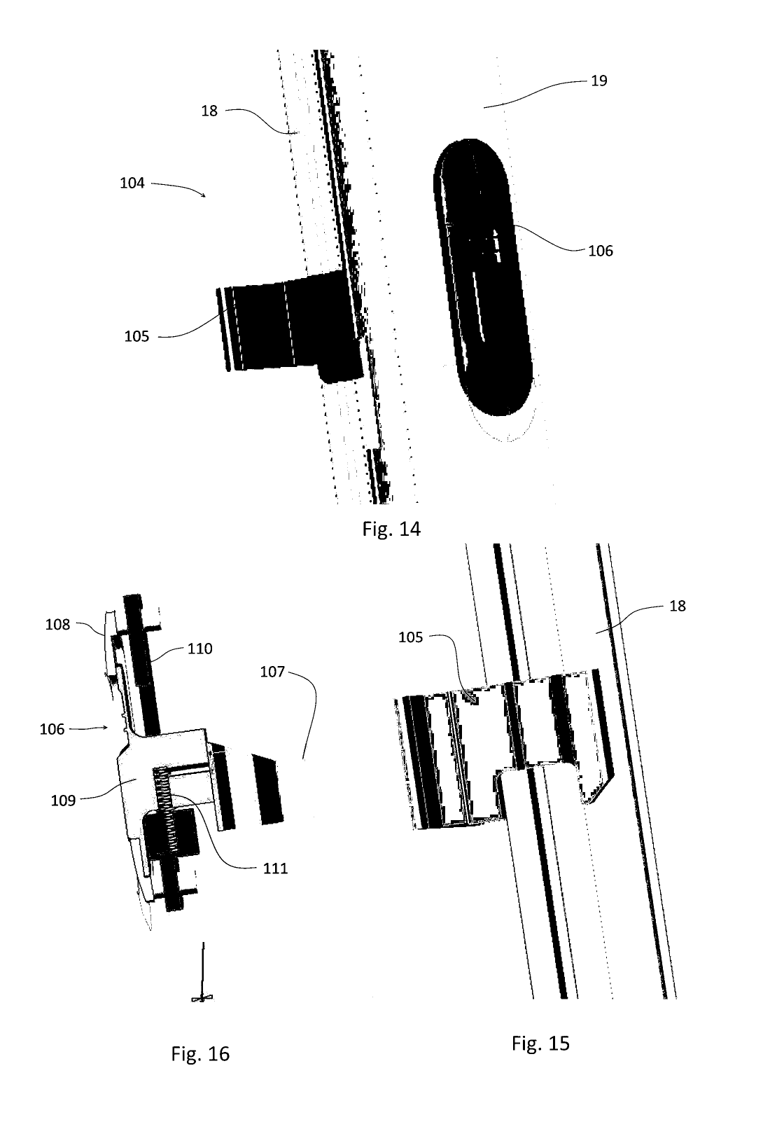

FIGS. 14, 15 and 16 show detail of a strut locking mechanism for the retractable awning according to the invention;

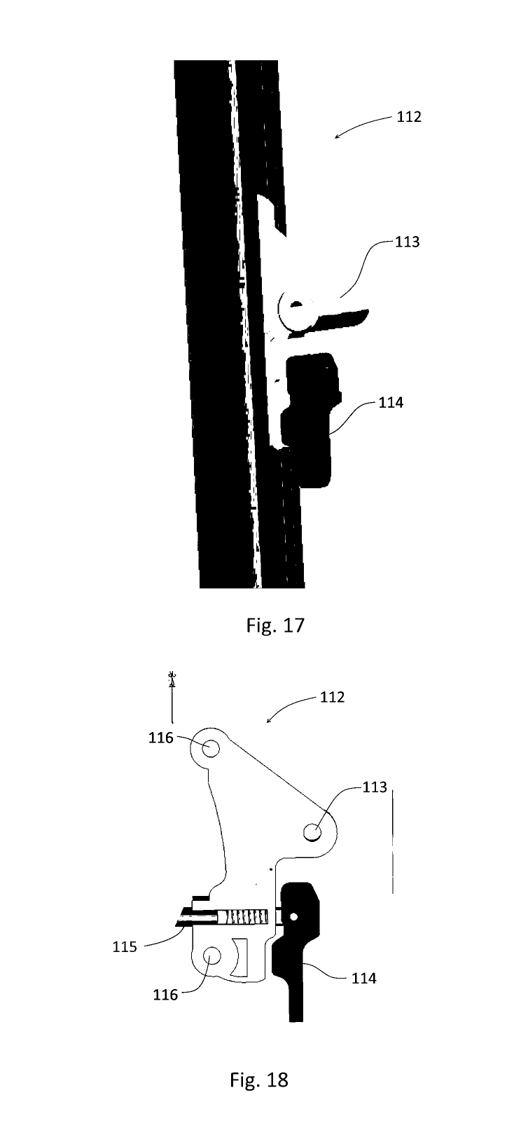

FIGS. 17 and 18 show in pictorial view and in section a lockable sliding carriage assembly for the connection of the strut to the guide rail of the retractable awning according to the invention;

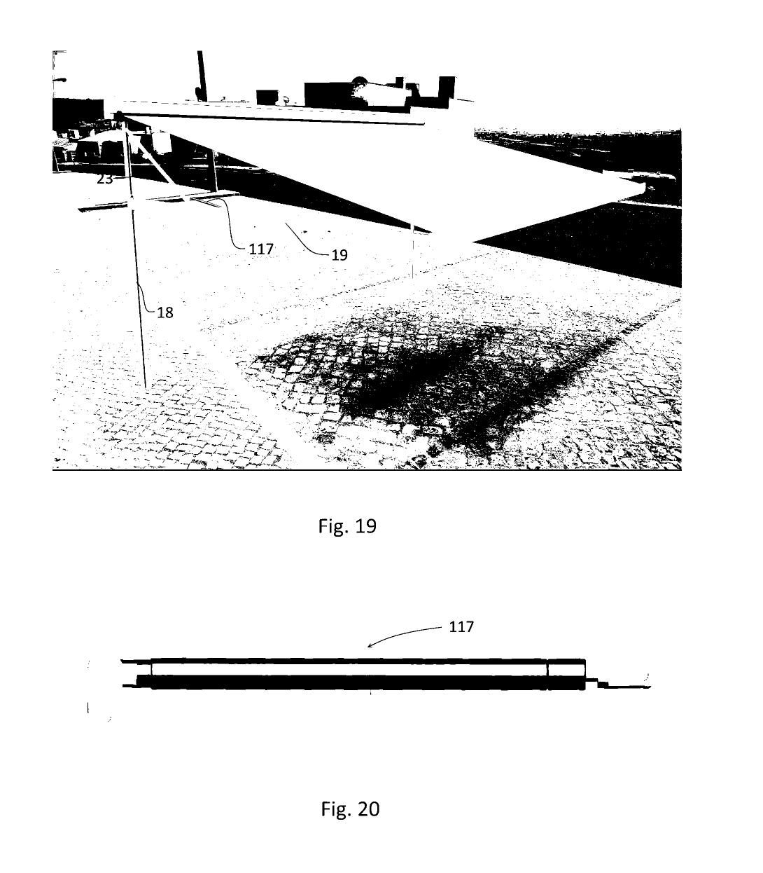

FIG. 19 is another view of the retractable awning according to the invention illustrated as a stand-alone awning; and

FIG. 20 is a pictorial view of a gas strut dampener for the retractable awning illustrated in FIG. 19.

### DESCRIPTION OF EMBODIMENTS

The awning assembly 10 illustrated in FIGS. 1, 2 and 3 according to this invention is typically mounted on the entry door side wall 11 of a caravan 12 such that when stowed the awning assembly does not interfere with the windows 13 or door opening 14 and the like of the caravan.

The awning assembly includes an upper housing assembly 15 which retractably supports a flexible covering 16, and respective support assemblies 17 adjacent the ends of the flexible covering. Each support assembly includes an upstanding guide rail 18 fixed to the caravan wall and a deployable strut 19, both of which, when stowed, nest together closely adjacent the sidewall of the caravan so as not to cause undue wind resistance during travel. When fully deployed, the struts extend substantially horizontally from the vertically disposed guide rails to support a longitudinal rail 20 to which the outer end of the flexible covering is attached. The housing assembly is illustrated without its end caps in place which may incorporate the retracting mechanism or drive means for manually or remotely retracting the covering.

Preferably the retracting mechanism is a spring operated mechanism which does not have a cam-lock mechanism for locking the supporting roller against rotation during retraction of the flexible covering so that only the position of the support assemblies control the extension/retraction. This ensures complete retraction of the fabric covering and maintains tension in the covering at all times. This arrangement also simplifies the retracting mechanism enabling enhanced reliability of the mechanism.

Each strut assembly has an inner end 21 which attaches pivotally to a carriage assembly 22 for guided up and down movement only along the guide rail. An upper slender control arm 23 is suspended pivotally at 24 from the upper end of each guide rail and extends downwardly and into an intermediate pivot mounting 25 within the associated strut so as to control the orientation of the respective strut as its inner end is moved along the associated guide rail. In the stowed attitude, an outer flange portion 26 of each U-sectioned strut engages about the guide rail to enclose the control arm and close the open fronted rail to reduce ingress of road grime and the like thereto.

The inner ends have their webs 27 cutaway so that shaped side flange end portions 26 can overlie the spaced apart outer returned flanges 29 of the rails 18 whereby lateral loads which may be accidentally or otherwise applied thereto can be accommodated by abutment between the flanges 26 and 29 and not through the carriage assembly. In addition this flange to flange engagement assists in providing lateral location of the strut assemblies when fully and partially deployed.

A supporting roller assembly 30, which is spring biased for winding the flexible covering onto a spindle forming part of the roller assembly, is supported within the housing assembly 15, which in use, is mounted so as to extend along the side wall of a caravan at or near the top and above the window and door openings. The flexible covering is retractably supported with its retractable or outer end 31 secured in a bolt rope track 32 extending along the longitudinal rail 20. In the stowed attitude the longitudinal rail closes an open bottom 33 of the housing assembly.

The longitudinal rail is fixed to the upper ends of the respective longitudinally spaced struts such that when the longitudinal rail is pulled away from the housing assembly it will be carried outwardly by the struts along a substantially horizontal path such that it remains easily accessible to the person deploying the awning who will not have to support the weight of the longitudinal rail or the flexible covering as at all times these are supported by the struts.

Fixed stops 35 are positioned in the rails 18 to limit the upward movement of the carriage assembly 22. These stops may be positioned to prevent movement of the inner ends beyond a position at which the struts are substantially horizontal, or alternatively as illustrated in FIG. 3, the stops are positioned higher along the rails 18 to permit the support struts to pivot beyond the horizontal attitude. This lowers the longitudinal rail relative to the ground 36 as indicated by the dimension line 37 to provide ease of access to the outer bolt rope ends of the flexible covering 16. This lowering may also be achieved by making the control arms 23 length adjustable so that the deployed height of the support rail 20 can be selectively varied, either up or down.

It will also be seen that the lower face 40 of the support rail 20 is provided with a captive slot 41 so that the connector members 42 which provide the connection between the longitudinal rail and the struts can be selectively positioned along the length of the longitudinal rail corresponding to positions of clear vertical panel portions on the caravan wall so that the associated rails can be selectively positioned where they will not interfere with caravan openings or on strong points of the wall structure such as alongside the doorway. This enables the awning assembly to be fitted to most caravans without causing interference to windows and the like.

Referring to the sectioned view in FIG. 4, it will be seen that each carriage assembly 22 has an upper mounting part 44 which supports vertically spaced rollers 45 at each side thereof which roll along the front and rear webs of the open section rail 18 and which protrudes through the front opening between the returned flanges 29 to support a mounting boss 47 which is through bolted to the side walls 48 of the struts 19 for pivotal connection thereto. Similarly the ends of the control arms 23 extend through the free inner edges of the outer flanges 26 and through the slot between the returned flanges 29. These ends are secured with further through-bolts to effect the respective pivotal connections to the strut 19 and the guide rail 18. Through bolts may also be utilised to form the stops in the guide rails 18.

The lower body part 49 of the carriage assembly 22 supports a stud 50 which projects between the returned flanges 29 to support a friction washer 51 secured by a wing nut 52 threadedly engaged with the stud. This forms a clamp assembly 53 in which the wing nuts may be tightened to clamp the carriage assembly 22 to the rail 18 at any desired position therealong. Accordingly, the tensioned flexible covering may be operatively secured in any partly deployed position simply by actuating the clamp assembly when the covering has been pulled from its housing a sufficient distance to suit the user.

It will also be seen that the arm 23 is relatively short so that as the strut pivots toward the horizontal attitude and simultaneously moves closer to the tensioned covering, the weight of the strut portion and longitudinal rail extending beyond the intermediate mounting 25 will overcome the tendency of the tensioned covering to retract the strut to its stowed attitude. As a result, when fully deployed the awning will remain in the deployed position without external influence and with maximum tension applied to the covering by the retracting mechanism. In this stable position a person deploying the awning may casually move toward the inner ends 21 to operate the clamp assemblies 53 and positively lock the awning in its fully deployed attitude.

Furthermore, if the user intends to fully deploy the awning for an extended stop the longitudinal rail may be dipped, as illustrated in FIG. 7, to make the free ends 37 of the bolt rope edges 56 accessible for slidably engaging stiffening bars 57 thereon. In this attitude the struts are much closer to being aligned with the flexible covering which will have insufficient tension to retract the longitudinal rail so that the operation of installing the stiffening rails may be carried out without fear of sudden unexpected movement of the awning. Of course the clamp assemblies may also be engaged as a further safety measure.

Each stiffening bar is formed from two separate lengths which engage telescopically with a common joiner 59 whereby they are length adjustable. Tongues 60 protrude from each remote end 61 of the assembled stiffening bar and engage non-rotatably in slots 62 formed in the deployed inner faces 40 of the longitudinal rail 20 and housing 15.

Referring to FIGS. 6, 7 and 8 it will be seen that the outer corners of the flexible covering are cropped at 63 to expose the outer ends 37 of the bolt rope edges 56 formed on the covering to enable the slotted stiffening bars 57 to be oriented for easy feeding onto the bolt rope edge 56 and thereafter rotated inwards to pull the edge 56 downward to permit the tongues 60 to be engaged in their respective slots 62 for securing the flexible edge against fluttering movement caused by wind action and to provide further captive slots 66 and 67 which may be used for adding walls or an awning extension or other purposes as desired.

As illustrated in FIG. 5, the underside of the longitudinal rail 20 is formed with a nut retaining slot 41 such that a T-shaped connector assembly 42 can be secured to the rail 20 at any desired position therealong, such as to coincide with a suitable rail mounting position on a caravan wall. The shaft 72 of each T-shaped connector assembly 71 is received in the strut 19 between its side walls 73 and between the back wall 74 and the opposed intermediate stiffening ribs 75 which extend in from each side wall 73. This shaft 72 may be fixed in place by screws or other mechanical fastening or bonding. In another embodiment this shaft 72 may be an elongate shaft of say or about one metre long which may be selectively extended from the outer end of the strut assembly and locked in a desired position, such as by clamping or by passing pins through registering apertures formed therein and in the strut, to increase the span of the awning.

FIG. 5 also illustrates the arrangement of feeding the flexible covering from the underside of the roller assembly 30 to a slot 32 adjacent the outer edge of the longitudinal rail such that the longitudinal rail is pulled to the closed position by tension in the covering. In addition, clamp screws 78 are provided at the upper end of each strut such that they may be positively locked to the rails 15 for transport.

A seal 80 located in an outer slot 81 formed in the housing assembly 15, which may be a lip seal or a brush-type seal, engages the rail 20 in its stowed attitude to span the gap between the rail 20 and the front wall 82 of the housing assembly 20. This seal also acts to wipe debris from the upper surface of the flexible covering as it is retracted into the housing to further assist in reducing debris into the housing which otherwise can build up and prevent even wrapping of the flexible covering about the roller which may cause it to jam or otherwise malfunction. A further seal 83 is located in a captive slot 84 provided at the back of the housing assembly 20 to effect a weatherproof connection between the housing assembly 20 and the wall to which it is attached.

In a preferred arrangement, as illustrated, the housing assembly 15 has a back wall configured to hook over the upper spaced lip 88 of a mounting bracket 89 which fixes permanently to the wall on which the awning assembly is to be mounted. This bracket provides a locking tab 90 which engages in front of the lower rear edge 91 to secure the housing assembly 15 to the bracket 89.

In this embodiment the bracket 89 is also provided with a depending angled flange 92 which is adapted to be received into the upper end of the slide rail 18 so that this rail may be secured to the mounting wall through a lower bracket which is screwed or otherwise fastened to the base of the wall and the bracket 89 and without the requirement for further fixings which penetrate the wall. If desired double sided tape and the like may be utilised to secure the intermediate portion of the slide rail to the wall.

The slide locking mechanism 100 illustrated in FIGS. 9 to 11 includes a slide lock body 101 and a slide lock lever 102 pivotally mounted thereto which can pivot between a lock position as shown in FIG. 9 and a release position as shown in FIG. 10. In the lock position, the struts are free to extend, but not retract against the retracting force applied by the tension of the flexible covering.

The rails shown in FIGS. 12 and 13 may further include a LED channel 103 along a portion of the extrusion selected to enable LED lighting to be installed for illuminating at last some of the space covered by the flexible canopy. The C-section channels are sized to receive the bolt rope.

The strut locking mechanism 104 illustrated in FIGS. 14, 15 and 16 by which the struts are held against the guide rails. The strut locking mechanism includes a strike plate 105 which also acts as a resting pad between the guide rail and the strut. The strike plate is co-operable with a latching mechanism 106 which has a latch formation 107 on a latch body 109 which has a thumb grip to permit sliding motion with respect to a bezel plate 108. The bezel plate is fastened to a backing plate 110. A spring 111 is interposed between the backing plate and the latch body to urge the latch body upwards to latch the strut against the guide rail.

The lockable sliding carriage assembly 112 illustrated in FIGS. 17 and 18 has a pivot for attachment of the strut and a lever 114 for locking the carriage assembly in a selected location along the guide rail. The lever actuates a spring loaded locking pin 115 to engage corresponding apertures in the guide rail. The carriage assembly also has two rail mount apertures through which wheels or guides 116 may be inserted to engage with complementary slots in the guide rail. of the retractable awning according to the invention; and

FIG. 19 is another view of the retractable awning according to the invention illustrated as a stand-alone awning, but specifically includes a gas strut dampener 117 between the deployable strut and control arm.

It will be seen that an awning according to aspects of this invention may be readily deployed and stowed by a single user either for short time use or for longer use when utilised with easily fitted anti-flap bars. It will also be seen that the simplicity of construction of awnings made in accordance with aspects of this invention will provide an awning assembly which will be relatively inexpensive to manufacture and reliable in use.

It will of course be realised that the above has been given by way of illustrative example of this invention and that all such modifications and variations thereto as would be apparent to persons skilled in the art will fall within the broad scope and ambit of the invention as is set forth herein and/or defined in the appended claims which embrace combinations which are to be regarded as combinations apparent from the description and disclosed therein.

What is claimed:

1. An awning assembly including:
a longitudinal rail assembly attached to the outer longitudinal edge of the flexible covering;
at least one strut assembly connected at one end to the longitudinal rail assembly and at its opposite end to a slide assembly adapted to be fixed to the supporting wall such that movement of the longitudinal rail assembly away from the supporting wall causes travel of the opposite end of the strut assembly along the slide assembly from a stowed position to a deployed position;
extension means for extending the strut assembly from a collapsed condition to an expanded position, and
control means for locating the strut assembly during movement between its stowed position and collapsed condition and its deployed position and expanded condition.

2. (canceled)

3. An awning assembly as claimed in claim 1, wherein the longitudinal support member includes a retracting roller supported within a housing.

4. An awning assembly as claimed in claim 3, wherein the housing is an open bottom housing which is operatively closed by the longitudinal rail assembly when disposed in its retracted position.

5. An awning assembly as claimed in claim 1, wherein the flexible covering is unwound from an underside of a retracting roller.

6. An awning assembly as claimed in claim 1, wherein the flexible covering is provided with a bolt rope edging along its respective transverse edges and which terminate spaced from the longitudinal support rail to expose accessible bolt rope ends adjacent the longitudinal support rail.

7. An awning assembly as claimed in claim 1, wherein the slide assembly includes an open vertical track adapted to be fixed to a sidewall of a caravan and operatively closed by the associated strut assembly when disposed in the stowed attitude.

8. An awning assembly as claimed in claim 1, wherein the strut assembly is adjustably connected to the longitudinal rail assembly.

9. An awning assembly as claimed in claim 1, wherein the control means is a link which extends down from a fixed pivot on or adjacent a caravan wall to a pivot on the strut assembly located between the ends thereof.

10. An awning assembly of the type including:
a longitudinal support assembly from which a flexible covering may be withdrawn to provide an awning roof extending from a supporting wall and retracted for stowage adjacent the supporting wall, wherein:
transverse edge portions of the flexible covering are provided with bolt rope edging which terminates in spaced relationship with the supported longitudinal edge of the deployed flexible covering which is distant from the wall to expose accessible bolt rope ends adjacent said longitudinal edge.

11. An awning assembly as claimed in claim 10, and including a stiffening bar adapted to be secured to each respective transverse edge portion by engaging an open end of a captive slot in the stiffening bar with the accessible rope ends and sliding the stiffening bar onto the respective transverse edge portion.

12. A method of installing a respective flutter dampening member to an unsupported transverse edge of the retractable flexible covering of a caravan awning, including:
providing a bolt rope type edge along said transverse edge such that an end portion of the bolt rope type edge remote from the caravan is accessible for engaging a complementary tracked member therewith for sliding along the bolt rope type edge, and
sliding a complementary tracked member onto the bolt rope type edge from a position spaced from the caravan and in a direction toward the caravan.

13. A method as claimed in claim 11 and including forming the caravan awning whereby the retractable edge of the flexible covering when deployed may be disposed in a supported lowered position at which the end portion of the bolt rope type edge may be accessed by an installer at a height below the normally deployed height of the retractable edge.

14. A method as claimed in claim 12, wherein the unsupported edge transverse edge is an edge of an awning assembly as claimed in claim 1.

15. (canceled)
